(19) United States
(12) Patent Application Publication
(10) Pub. No.: US 2015/0059478 A1
(43) Pub. Date: Mar. 5, 2015

(54) METHOD AND MEASURING ARRANGEMENT FOR MONITORING OPERATIONAL STATES OF A SLIDE BEARING

(71) Applicants: Hans-Henning Klos, Feucht (DE); Klaus-Dieter Müller, Nuremberg (DE); Michael Steckenborn, Berlin (DE)

(72) Inventors: Hans-Henning Klos, Feucht (DE); Klaus-Dieter Müller, Nuremberg (DE); Michael Steckenborn, Berlin (DE)

(73) Assignee: SIEMENS AKTIENGESELLSCHAFT, München (DE)

(21) Appl. No.: 14/394,042

(22) PCT Filed: Apr. 19, 2012
(86) PCT No.: PCT/EP2012/057177

§ 371 Date: Oct. 10, 2014

(51) Int. Cl. G01N 29/44; F03D 11/00; G01M 13/04; F16C 41/00; G01N 29/04

(52) U.S. Cl. CPC G01N 29/44; F16C 41/00; G01N 29/04; G01M 13/045; F03D 11/0091; F16C 2233/00
USPC 73/602

(57) ABSTRACT

The operational state of a slide bearing is monitored by determining measurement values that characterize noise emissions in the slide bearing using a sensor element which is mechanically coupled to the slide bearing. A characteristic value is calculated from determined measurement values and the operational state of the slide bearing is classified according to the characteristic value.

### CROSS REFERENCE TO RELATED APPLICATIONS

This application is the U.S. national stage of International Application No. PCT/EP2012/057177, filed Apr. 19, 2012 and claims the benefit thereof. The International Application is incorporated by reference herein in their entirety.

### BACKGROUND

Described below are a method for monitoring an operational state of a slide bearing, a measuring arrangement for monitoring an operational state of a slide bearing and a slide bearing arrangement.

Slide bearings are being used increasingly frequently in the area of large machines, for example in transmissions or wind turbines. However, damage to the slide bearing all too often leads to extreme consequential damage. Monitoring the state of the slide bearings allows early identification of critical operational states and makes it possible to initiate corresponding countermeasures.

It is known to determine increased friction in the slide bearing by monitoring the temperature of the slide bearing. Knowledge of the temperature of the lubricant allows statements to be made about the viscosity of the lubricant if no additional viscosity measurement takes place. Furthermore, large particles and contaminants of the lubricant can be determined with a particle counter. Moreover, the load moment can also be investigated for monitoring the operational state. Vibrations of the shaft can be determined by analyzing vibrations in the low-frequency range.

However, the frictional state of the bearing cannot be determined directly by the methods described above. Particles that are generated in the bearing and remain there also cannot be detected. The monitoring of the temperature of the slide bearing is bound to many dependent factors, which prevent a reliable diagnosis of the slide bearing. What is more, damage to the slide bearing and particles in the slide bearing cannot be determined directly. Furthermore, under some circumstances the load moment falls when there is increasing friction in the bearing, and consequently cannot be regarded as providing a reliable measurement for the diagnosis of the slide bearing.

In the article “Schadensfrüherkennung an geschmierten Gleitkontakten mittels Schallemissionsanalyse” [early damage detection on lubricated sliding contacts by sound emission analysis] by M. Fritz et al., the investigation of sound emissions in the ultrasonic range in a slide bearing is described. This involved investigating the frequency spectrum of the sound emissions in dependence on the torque, the temperature of the slide bearing and the loading.

### SUMMARY

The method provides a way in which operational states of slide bearings can be determined easily and quickly.

The method for monitoring an operational state of a slide bearing includes determining measured values that characterize sound emissions in the slide bearing with a sensor element that is mechanically coupled to the slide bearing, calculating a characteristic value on the basis of the measured values determined and classifying the operational state of the slide bearing in dependence on the characteristic value.

The operational state of the slide bearing may change as a result of external or internal stresses in the slide bearing. As a result, for example, mechanical stresses may occur in the parts of the slide bearing. The release of elastic energy typically causes sound emissions in the slide bearing. These sound emissions, which are also referred to as acoustic emission, have frequencies in the ultrasonic range, in particular in a frequency range between 50 and 150 kHz. The frequencies of the sound emissions are dependent on the material. Thus, for example, in the case of steel, frequencies in the range of 110 kHz usually occur. The sound emissions can be determined with the sensor element that is connected to the slide bearing or a housing of the slide bearing in such a way that the sound emissions can be transmitted to the sensor element by way of structure-borne sound. The sensor element may be designed as an acceleration sensor, a pressure sensor or in the manner of a strain gage. In particular, the sensor element is designed as a micromechanical sensor.

With a computing device, a characteristic value can be calculated from the variation over time of the measured values that is determined with the sensor element. The classification of the slide bearing can be carried out automatically with the computing device. For this purpose, predetermined operational states and the associated characteristic values may be stored in the computing device or a corresponding memory device of the computing device. The operational states may be assigned to abrasion, damage or wear of the bearing. The operational states may concern a state of the lubricant in the slide bearing or a contamination of the lubricant by particles. The extent of the contamination or the size, number or material of the particles may also be taken into account here. Similarly, the operational states may be assigned to different frictional states of the slide bearing, such as for example high-wear mixed friction or low-wear fluid friction.

Calculation of a characteristic value allows the items of information or measured values determined with the sensor element to be compressed. Moreover, corresponding features can be extracted from the measured values. In spite of the smaller amount of data, a reliable statement concerning the present operational state of the slide bearing can be made. It is thus possible in an easy and effective way to detect damage to the slide bearing at an early time and, if appropriate, to initiate corresponding measures.

In one embodiment, the characteristic value is calculated in dependence on a maximum value and/or a root mean square value of the measured values. The characteristic value may in this case be calculated in dependence on the maximum value and/or the root mean square value of the measured values for a prescribed time period or a time window. The characteristic value may also be calculated here as a logarithmic measure. The use of a reciprocal characteristic value is also conceivable. The product of the maximum value and the root mean square value may also be used as a characteristic value. The relationship with a reference root mean square value and/or a reference maximum value of the measured values may also be calculated to form the characteristic value. The reference values can be determined in an easy way, since, with the desired operation in fluid friction, these values are dependent only very little on the rotational speed, the temperature of the lubricant and the bearing load.

In a further embodiment, the characteristic value is calculated on the basis of an envelope signal determined from the measured values. Such an envelope signal may be determined for example by rectification and low-pass filtering of the measured values. In the same way, the envelope signal may be determined by calculation of a sliding root mean square value or a sliding average value of the measured values. A further possibility is to determine the envelope signal by a Hilbert transform.

The characteristic value may be calculated on the basis of a frequency spectrum of the envelope signal. By corresponding frequency analysis of the envelope signal, for example by a fast Fourier transform (FFT), the periodically recurring signals and pulses in the measured values or the acoustic emission signals can be determined. In this way it is possible for example to easily determine particles in the lubricant that generate periodically recurring signals in dependence on the rotational speed.

In a further embodiment, the characteristic value is calculated from a correlation of the measured values. The characteristic value can be calculated from the correlation or the autocorrelation of the measured values. Various frequency ranges of the measured values can be investigated in this way, by variation of the time window. A corresponding correlation method can also be used for the frequency analysis of the measured values, in particular if the frequencies to be investigated are known. A simple and quick algorithm is thereby obtained and, as a result, the signal-to-noise ratio can be improved significantly, in particular when averaging over a number of shaft revolutions.

The measuring arrangement for monitoring an operational state of a slide bearing includes a sensor element for determining measured values that characterize sound emissions in the slide bearing when there is mechanical coupling to the slide bearing and a computing device that is designed for calculating a characteristic value on the basis of the measured values determined with the sensor unit and classifying the operational state of the slide bearing in dependence on the characteristic value.

The measuring arrangement may have an amplifier element for amplifying the measured values determined, a filter element for filtering the measured values amplified by the amplifier element and an analog-to-digital converter, which is coupled to an input of the computing device. The sensor element can determine the sound emissions in the slide bearing. The output signal of the sensor element, which is for example in the form of an electric voltage or an electric current intensity, can be boosted or amplified by the amplifier element. The amplified signal is corrected to eliminate disturbing or irrelevant frequency bands by an analog filter element before it is fed to the analog-to-digital converter. This arrangement allows the signal-to-noise ratio to be improved. The filter element may also be used for determining an envelope signal from the measured values. The computing device may be designed as a PC or microprocessor. With the computing device, information compression can be carried out by feature extraction and characteristic value formation.

The sensor element, the amplifier element, the filter element, the analog-to-digital converter and the computing device (processor) may be arranged in a common housing. This arrangement allows the susceptibility to interference to be reduced.

The slide bearing arrangement includes a slide bearing and a previously described measuring arrangement, which is mechanically coupled to the slide bearing. With the slide bearing arrangement, evident effects of abrasion on the slide bearing can be detected at an early time. Moreover, it is easily possible to distinguish between the operational states of mixed friction and fluid friction. The identification of the operational state can in this case take place independently of the bearing load and the shaft speed. In addition, the state of the lubricant and contaminants or particles in the lubricant can be determined. In the case of new hydrodynamic bearings or bearings operated with solid friction, it is possible to monitor the running-in process and to make statements about the extent to which this process has been completed.

### BRIEF DESCRIPTION OF THE DRAWINGS

These and other aspects and advantages will become more apparent and more readily appreciated from the following description of the accompanying drawings of which:

FIG. 1 is a slide bearing arrangement in a perspective representation;

FIG. 2 is a flowchart of a method for monitoring a slide bearing;

FIG. 3 is a block diagram of a measuring arrangement in a first embodiment;

FIG. 4 is a block diagram of a measuring arrangement in a second embodiment; and

FIG. 5 is a block diagram of a measuring arrangement in a third embodiment;

### DETAILED DESCRIPTION OF THE PREFERRED EMBODIMENT

Reference will now be made in detail to the exemplary embodiments described in more detail below which represent preferred embodiments, examples of which are illustrated in the accompanying drawings, wherein like reference numerals refer to like elements throughout.

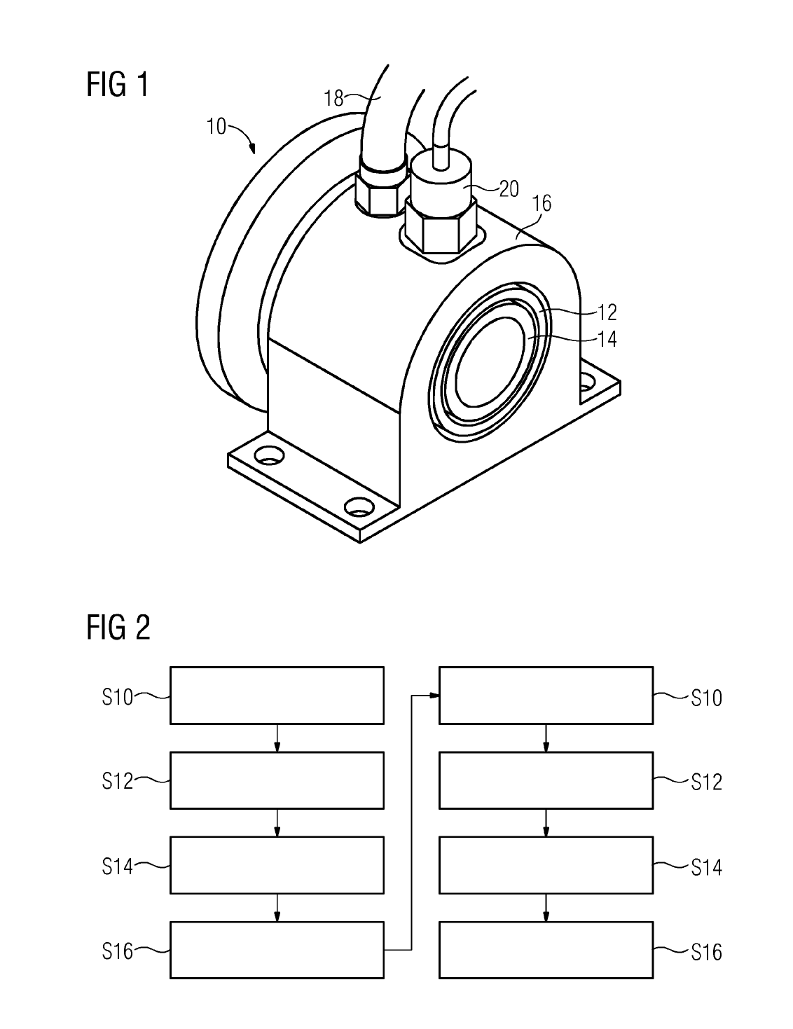

FIG. 1 shows a slide bearing arrangement 10 in a perspective representation. The slide bearing arrangement 10 has a slide bearing 12, which carries a shaft 14. The slide bearing 12 is arranged in a housing 16. Furthermore, the slide bearing arrangement 10 has a connection 18, by way of which lubricant, in particular an oil, is fed to the slide bearing 12. Arranged on the housing 16 of the slide bearing 12 is a measuring arrangement 20.

The measuring arrangement 20 is arranged directly on the housing 16. Consequently, sound emissions that are generated in the slide bearing 12 can be transmitted by way of structure-borne sound to a sensor element 22 that is not represented in FIG. 1. The sensor element 22, which is located inside the measuring arrangement 20, is designed for determining sound emissions with frequencies in the ultrasonic range, which are also referred to as acoustic emission. In particular, the sensor element 22 is designed for determining sound emissions in the range from 50 kHz to 150 kHz. The sensor element 22 may be designed as an acceleration sensor or as a pressure sensor. Similarly, the sensor device may be designed in the manner of a strain gage. The sensor element 22 may be a micromechanical sensor, which may for example include a seismic mass. As an alternative to this, the sensor element 22 may include a piezoelectric sensor element.

FIG. 2 shows a method for monitoring operational states of a slide bearing 12 in a schematic representation. Firstly, in S10, the slide bearing 12 is subjected to external stress. This may for example take the form of particles or contaminants penetrating into the slide bearing 12. In S12, the external stress to which the slide bearing 12 is subjected causes mechanical stresses to occur in the material of the slide bearing 12. These mechanical stresses stimulate sources of acoustic emission (S14). Consequently, high-frequency sound emissions or structure-borne sound is/are generated in the material of the slide bearing 12 and in S16 propagate(s) in the slide bearing 12. The frequencies of the sound emissions are dependent on the material and usually lie in the range from 50 to 150 kHz.

In S18, the sound emissions are determined by the sensor element of the measuring arrangement 20. Subsequently, in S20, information compression takes place by feature extraction and characteristic value formation. In S22, an evaluation of the data takes place. Finally, in S24, a classification of the operational state of the slide bearing 12 is carried out.

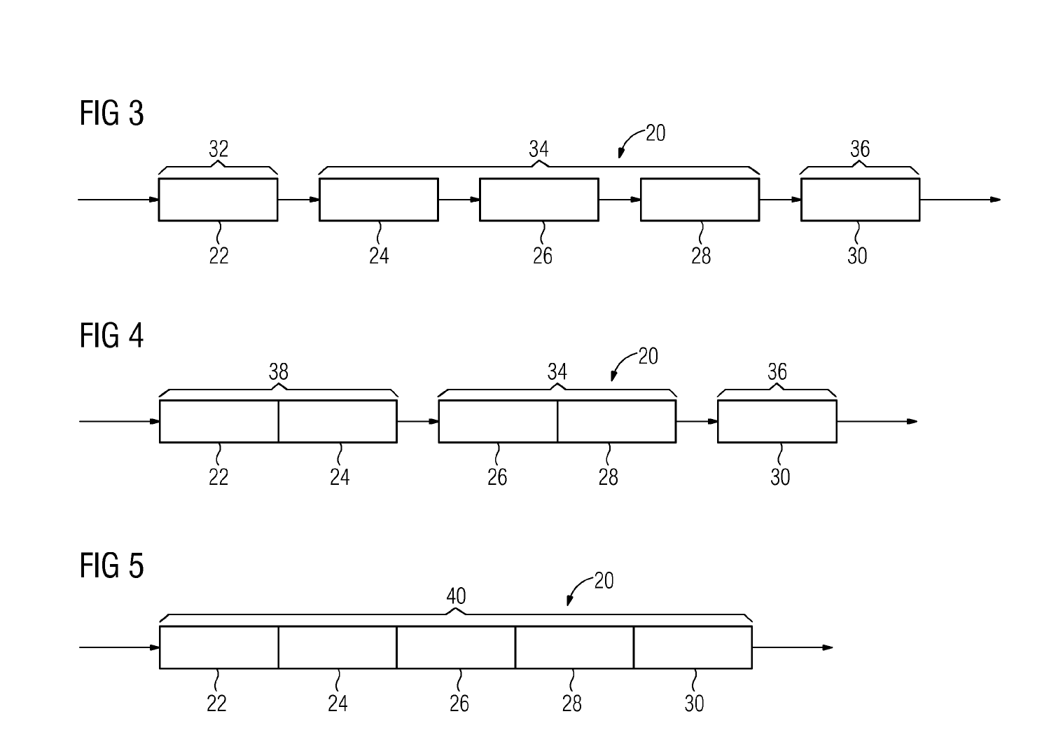

FIGS. 3, 4 and 5 respectively show a measuring arrangement 20 in various embodiments. Each of the measuring arrangements 20 has a sensor element 22, with which sound emissions in the slide bearing 12 are determined as a variation of measured values over time when there is mechanical coupling to the slide bearing 12. The output signal of the sensor element 22, which takes the form for example of a temporal signal of an electric voltage or an electric current intensity, is transmitted to an amplifier element 24. The output signal is amplified by the amplifier element 24. The amplified signal is corrected by an analog filter element 26 to eliminate disturbing or irrelevant frequency bands before it is fed to the analog-to-digital converter 28. The filter element may also be used for determining an envelope signal from the measured values by rectification and low-pass filtering. From the analog-to-digital converter 28, the digitized measured values are transmitted to a computing device 30, which may be designed as a PC or microprocessor.

With a computing device 30, a characteristic value is calculated from the variation over time of the measured values. On the basis of this characteristic value, the operational state of the slide bearing 12 can be classified. The classification of the slide bearing 12 may also be carried out automatically by the computing device 30. In this way the abrasion of the slide bearing 12 can be determined. Furthermore, the state of the lubricant in the slide bearing 12 or contamination of the lubricant by particles can be determined. Moreover, the different frictional states of the slide bearing 12, such as for example high-wear mixed friction or low-wear fluid friction, can be determined.

In the exemplary embodiment represented in FIG. 3, the sensor element 22 is arranged separately, for example in a housing. This is illustrated by the brace 32. The signal conditioning is performed by the amplifier element 24, the filter element 26 and the analog-to-digital converter 28 (illustrated by the brace 34). The processing of the signal that is represented by the brace 36 takes place in the computing device 30.

In the embodiment of the measuring arrangement 20 according to FIG. 4, the amplifier element 24 is integrated in the sensor element 22. This realizes an integrated sensor (brace 38), which has the advantage of a lower susceptibility to interference. The further signal conditioning by the filter element 26 and the analog-to-digital converter 28 may take place in a further module, which is indicated by the brace 34. As described above, the signal processing takes place in the computing device 30.

In the case of the measuring arrangement 20 according to FIG. 5, the determination of the measured values, the amplification, the filtering, digitizing and processing take place in a diagnostic module, which is indicated by the brace 40. In this case, the sensor element 22, the amplifier element 24, the filter element 26, the analog-to-digital converter 28 and the computing device 30 are arranged in a common housing. This variant has a particularly low susceptibility to interference.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-8. (canceled)

9. A method for monitoring an operational state of a slide bearing, comprising:
determining measured values that characterize sound emissions in the slide bearing in a frequency range between 50 kHz and 150 kHz using a sensor element that is mechanically coupled to the slide bearing;
calculating a characteristic value from a correlation of the measured values as one of a logarithmic measure and reciprocally; and
classifying the operational state of the slide bearing in dependence on the characteristic value.

10. The method as claimed in claim 9, wherein the characteristic value is calculated in dependence on at least one of a maximum value and a root mean square value of the measured values.

11. The method as claimed in claim 10, wherein the characteristic value is calculated based on an envelope signal determined from the measured values.

12. The method as claimed in claim 11, wherein the characteristic value is calculated based on a frequency spectrum of the envelope signal.

13. The method as claimed in claim 9, wherein the characteristic value is calculated based on an envelope signal determined from the measured values.

14. The method as claimed in claim 13, wherein the characteristic value is calculated based on a frequency spectrum of the envelope signal.

15. A measuring arrangement for monitoring an operational state of a slide bearing, comprising:
a sensor element determining measured values that characterize sound emissions in the slide bearing in a frequency range between 50 kHz and 150 kHz when there is mechanical coupling to the slide bearing; and
a computing device calculating a characteristic value from a correlation of the measured values as one of a logarithmic measure and reciprocally, and classifying the operational state of the slide bearing in dependence on the characteristic value.

16. The measuring arrangement as claimed in claim 15, further comprising:
an amplifier amplifying the measured values;
a filter, coupled to the amplifier, filtering the measured values amplified by the amplifier; and
an analog-to-digital converter, coupled to the filter and an input of the computing device.

17. The measuring arrangement as claimed in claim 16, further comprising a common housing in which the sensor element, the amplifier element, the filter element, the analog-to-digital converter and the computing device are arranged.

18. A slide bearing arrangement, comprising:
a slide bearing; and
a measuring arrangement, mechanically coupled to the slide bearing, including
a sensor element determining measured values that characterize sound emissions in the slide bearing in a frequency range between 50 kHz and 150 kHz when there is mechanical coupling to the slide bearing; and
a computing device calculating a characteristic value from a correlation of the measured values as one of a logarithmic measure and reciprocally, and classifying the operational state of the slide bearing in dependence on the characteristic value.

19. The slide bearing arrangement as claimed in claim 18, wherein the measuring arrangement further includes
an amplifier amplifying the measured values;
a filter, coupled to the amplifier, filtering the measured values amplified by the amplifier; and
an analog-to-digital converter, coupled to the filter and an input of the computing device.

20. The measuring arrangement as claimed in claim 19, wherein the measuring arrangement further includes a common housing in which the sensor element, the amplifier element, the filter element, the analog-to-digital converter and the computing device are arranged.
